(19) United States
(12) Patent Application Publication
(10) Pub. No.: US 2009/0075539 A1
(43) Pub. Date: Mar. 19, 2009

(54) Intumescent Materials

(75) Inventors: Felix A. Dimanshteyn, West Hartford, CT (US); Richard J. Barone, Wilton, CT (US)

Correspondence Address: EDWARDS ANGELL PALMER & DODGE LLP, P.O. BOX 55874, BOSTON, MA, 02205, US

(73) Assignee: TPR2 Vinyl Corporation, Richmond Hill, GA (US)

(21) Appl. No.: 11/664,465

(22) PCT Filed: Sep. 27, 2005
(86) PCT No.: PCT/US2005/034599

§ 371 Date: Apr. 22, 2008

Related U.S. Application Data
(60) Provisional application No. 60/615,013, filed on Oct. 1, 2004.

(51) Int. Cl. B32B 3/00; D03D 9/00; B32B 27/12; B32B 27/36; B32B 5/18; C08J 9/00; B29C 47/00; B32B 5/24; B32B 27/30; B32B 27/32

(52) U.S. Cl. 442/1; 442/286; 442/394; 442/287; 442/288; 442/290; 442/395; 442/396; 442/398; 442/221; 442/370; 264/319; 264/41; 521/53

(57) ABSTRACT

Fire-retardant, heat-resistant, smoke-suppressant plastic materials, such as polyvinyl chloride, having incorporated therein an intumescent material are disclosed. The intumescent material comprise and intumescent catalyst selected from the group consisting of salts of phosphoric acid and salts of sulfuric acid; and a carbonific material selected from the group consisting of starches, sugars, sugar alcohols, oils, and plasticizers. The fire-retardant, heat-resistant, smoke-suppressant plastic materials may be in the form of a foamed or non-foamed plastic. Methods of making such plastic materials are also disclosed.

### FIELD OF INVENTION

The present invention relates to materials having improved heat-resisting, flame-retarding, and smoke-suppressing properties. More particularly, the invention relates to the use of intumescent systems to reduce the propensity of materials, such as vinyl, to ignite or smoke when exposed to heat or flames.

### BACKGROUND OF THE INVENTION

Since its introduction as a building material in the 1950's, vinyl has become ubiquitous in the home and is commonly found in siding, pipes, windows, roofing, fencing, decking, wall-coverings and flooring. The most common vinyl polymer used in these applications is polyvinyl chloride (“PVC”) which is moderately flammable and produces corrosive hydrochloric acid and large amounts of smoke on combustion. See C. J. Hilado, Flammability Handbook for Plastics, Technomic, Stamford, Conn., 1969. The use of plasticizers also increases the flammability of these materials. There is also a great deal of controversy surrounding the possible toxicity of PVC combustion by-products. See “PVC in Fires,” The British Plastics Federation, London, April 1996, 12. Accordingly, the art has sought to reduce the propensity of vinyls, such as PVC, to ignite or smoke when exposed to heat or flames.

Traditional methods for improving the fire-retardancy of vinyl products, such as PVC, include the application of protective coatings to the vinyl surface, incorporation of co-monomers containing fire-retardant elements into the vinyl polymeric structure, and the use of fire resistant additives. Protective coatings have been widely employed in appliance housings and the like because the coatings can be applied to vinyl surfaces near the location of the fire hazard without adversely affecting the physical properties of the polymer. The use of co-polymerization with fire-retardant monomers, as disclosed in, for example U.S. Pat. Nos. 3,062,792 and 4,444,969, has not, to date, achieved widespread use. The most promising and widely applicable method for improving the fire-retardancy of PVC is the physical incorporation of fire-retardant additives in the polymer. The use of additives to improve the fire-retardancy of PVC and other vinyl polymers is particularly promising because the post-manufacture coating step is eliminated and the fire-retardant properties may be more durable. Traditionally, this approach has involved incorporating chemicals which undergo endothermic reactions, such as Al(OH)₃ and Mg(OH)₂, into the polymer during the extrusion process. The use of TiO₂ and ferric oxide has also been suggested to reduce fire spread and smoke and gas generation from heated PVC (See U.S. Pat. Nos. 6,316,118 to Watanabe, et al. and 3,993,607 to Florence). However, the benefits of inorganic additives such as Al(OH)₃ and Mg(OH)₂ comes at a cost to the mechanical properties of vinyl because these chemicals typically must be added at levels up to 60% by weight to be effective. For a general discussion of conventional fire-retardants, see Lyons, The Chemistry & Uses of Fire-retardants, Wiley & Sons (1970), Chapter 7, pp. 297-301 and Scharf, D. et al., Studies on Flame Retardant Intumescent Char: Part 1, Fire Safety Journal 19, pp. 103-117, Elsevier (Ireland, 1992), the contents of which are hereby incorporated by reference herein.

In the field of protective coatings, it is known to employ so-called intumescent materials in the coating. These are materials that react in the presence of heat to produce incombustible residues (“char”) which expand to a cellular foam having good insulation properties. Generally, intumescent materials comprise a carbonific material, typically a polyhydridic substance, such as a sugar or polyol, and an intumescent catalyst which is a dehydrating agent, such as phosphoric acid, usually introduced as a salt or ester. Upon heating, the acid is believed to catalyze the dehydration of the polyol to polyolefinic compounds which are subsequently converted to carbon char. “Blowing agents” which release nonflammable gases upon heating may be used to facilitate formation of the cellular foam. See Lyons, The Chemistry & Uses of Fire-retardants, Wiley & Sons (1970), Chapter 7, pp. 297-301. Fire resistant intumescent coatings are well known and disclosed in, for example, U.S. Pat. No. 5,759,692 to Scholz, et al., U.S. Pat. No. 5,603,990 to McGinniss, et al., U.S. Pat. No. 5,225,464 to Hill, U.S. Pat. No. 5,035,951 to Dimanshteyn, U.S. Pat. No. 4,144,385 to Downing, et al., U.S. Pat. No. 4,065,394 to Pratt et al., U.S. Pat. No. 3,955,987 to Schaar, U.S. Pat. No. 3,448,075 to Clark et al., U.S. Pat. No. 3,442,046 to Thomas et al., U.S. Pat. No. 3,021,293 to Simon, U.S. Pat. Nos. 2,755,260 and 2,684,953 to Stilbert et al., U.S. Pat. No. 2,600,455 to Wilson et al., U.S. Pat. No. 2,566,964 to Scholtz et al., U.S. Pat. No. 2,523,626 to Jones et al., U.S. Pat. No. 2,452,054 to Jones et al., U.S. Pat. No. 2,452,055 to Jones et al., Belgian Patent No. 669,341; British Patent No. 874,762; Japanese Patent No. 5278, British Patent No. 978,623, the disclosures of which are hereby incorporated by reference herein.

More recently, efforts have been made to incorporate intumescent systems as additives to improve the fire-retardancy of vinyl polymers. For example, M. Buganjy et al., Polym. Int. 48: 264-270 (1999), discloses an intumescent additive comprising ammonium polyphosphate as an intumescent catalyst and an ester of tris(2-hydroxyethyl) isocyanurate as carbonization and blowing agent bounded by an epoxy resin (Hostaflam AP 750 from Clariant, EP 0 735 119 A1) which is reported to provide good fire-retardant properties to ethylene-vinyl acetate copolymers when incorporated at levels of 30% by weight.

U.S. Pat. No. 6,790,893 to Nguyen, et al. discloses an intumescent powder defined by the molar ratios (2.20 to 3.70) SiO₂/(0.20 to 0.35) Li₂O: (0.65 to 0.80)(Na₂O+K₂O) where the coefficients of Li₂O and of (Na₂O+K₂O) total 1.00 as an additive to thermoplastic materials, such as PVC, having a plastic state at less than 195° C. U.S. Pat. No. 6,706,793 to Abu-Isa, et al. discloses intumescent additives for halogenated polymers comprising antimony oxide and an intercalated graphite. U.S. Pat. No. 4,341,694 to Halpern discloses intumescent flame retardant compositions including 2,6,7-trioxa-1-phosphobicyclo[2.2.2.]octane-4-methanol-1-oxide and a nitrogen compound selected from the group melamine, ammeline, benzoguanidine, guanidine, urea, and salts thereof as additives for polymers such as PVC. U.S. Pat. No. 5,204,393 to Nalepa et al. describes a flame retardant intumescent polyolefin which comprises a combination of ammonium polyphosphate, tris(2-hydroxyethyl) isocyanurate; melamine cyanurate, and a silica. U.S. Pat. No. 6,632,442 to Chyall, et al. discloses an intumescent polymer composition that includes a matrix polymer, an acid catalyst source, a nitrogen source and an ionic phyllosilicate. The disclosures of these patents are hereby incorporated by reference herein.

However, it has not, to date, proven economically feasible to employ many of these intumescent additives in a wide variety of applications. Therefore, despite these advances, there is a continuing need in the art for plastic materials, including vinyl materials such as PCV, that incorporate intumescent materials. More particularly, there is a need for economical intumescent additives that can be used to improve the flame retardancy of common plastic products, such as, for example, vinyl siding.

It is, therefore, an object of the present invention to provide intumescent additives that reduce the propensity of polymeric materials, such as vinyl and especially PVC, to smoke, ignite, or warp when exposed to heat or flames.

It is further an object of the invention to provide polymeric materials that include the intumescent additives, having a reduced propensity to smoke, ignite, or warp when exposed to heat or flames, and methods for making these materials.

An additional object of the invention is to provide polymeric materials, especially vinyls such as PVC, having a reduced propensity to smoke, ignite, or warp when exposed to heat or flames, which have improved physical properties when exposed to heat and mechanical properties which are comparable to or superior to conventional vinyl.

### SUMMARY OF THE INVENTION

In accordance with the foregoing objectives and others, the present invention provides highly efficacious intumescent additives which can be added to a variety of polymeric materials, such as plastics, to improve their fire-retarding, smoke-suppressing, and heat-resisting properties.

One aspect of the present invention provides a plastic material comprising: (1) a plastic polymer; and (2) an intumescent composition. The intumescent composition according to this aspect of the invention comprises: (a) an intumescent catalyst selected from the group consisting of salts of phosphoric acid and salts of sulfuric acid; and (b) a carbonific material selected from the group consisting of starches, sugars, sugar alcohols, oils, and plasticizers. The plastic materials have a reduced propensity to ignite, smoke or deform when exposed to heat or flames. The plastic polymer is preferably a polymer selected from the group consisting of polyvinyl chloride, polyester, polypropylene, polyethylene, and polyurethane. More preferably, the plastic polymer is a vinyl, particularly polyvinyl chloride (“PVC”).

In a related aspect of the invention, plastic material comprising: (1) a plastic polymer selected from the group consisting of polyvinyl chloride, polyester, polypropylene, polyethylene, and polyurethane; and (2) an intumescent composition are provided. The intumescent composition comprises: (a) an intumescent catalyst comprising NH₄)₂SO₄; and (b) a carbonific material selected from the group consisting of corn starch, corn oil, vegetable oil, and plasticizers. The plastic material has a reduced propensity to ignite, smoke or deform when exposed to heat or flames.

Plastic materials comprising: (1) polyvinyl chloride; and (2) an intumescent composition are also provided. The intumescent composition comprises: (a) an intumescent catalyst comprising (NH₄)₂SO₄; and (b) a carbonific material comprising corn oil. The plastic materials have a reduced propensity to ignite, smoke or deform when exposed to heat or flames.

One interesting plastic material according to the invention is a fire retarding, smoke-suppressing, heat-resistant foamed plastic comprising the intumescent additives of the invention. Methods for making such foamed plastics are also provided.

According to this aspect of the invention, foamed plastic materials comprising: (1) a plastic polymer; and (2) an intumescent composition are provided. The intumescent composition comprises: (a) an intumescent catalyst selected from the group consisting of salts of phosphoric acid and salts of sulfuric acid; and (b) a carbonific material selected from the group consisting of starches, sugars, sugar alcohols, oils, and plasticizers. The foamed plastic materials have a reduced propensity to ignite, smoke or deform when exposed to heat or flames and have the form of a foam.

In a related aspect, a foamed plastic material comprising: (1) a plastic polymer selected from the group consisting of polyvinyl chloride, polyester, polypropylene, polyethylene, and polyurethane; and (2) an intumescent composition is provided. The intumescent composition comprises: (a) an intumescent catalyst comprising (NH₄)₂SO₄; and (b) a carbonific material selected from the group consisting of corn starch, corn oil, vegetable oil, and plasticizers. The plastic material has a reduced propensity to ignite, smoke or deform when exposed to heat or flames and has the form of a foam.

Similarly, a foamed plastic material comprising: (1) polyvinyl chloride; and (2) an intumescent composition is provided. The intumescent composition comprises: (a) an intumescent catalyst comprising (NH₄)₂SO₄; and (b) a carbonific material comprising corn oil. The plastic material has a reduced propensity to ignite, smoke or deform when exposed to heat or flames and has the form of a foam.

The plastic materials of the invention are particularly suitable for the production of building materials such as, for example, vinyl siding, wiring, wire sheathing, cabling, and products such as, for example, plastic bowls, jars, and the like.

The fire-retardant, smoke-suppressant, and heat-resistant properties of the plastic materials according to this aspect of the invention may be further improved by the addition of inert additives such as fiberglass, including chopped fiberglass fibers, which can replace a portion of the flammable components typically found in such products. Surprisingly, the addition of inert additives such as fiberglass has been found to improve the physical and mechanical properties of plastic products, particularly in the presence of heat.

Further improvements to heat-resistant, flame retardant, smoke-suppressing plastic materials are provided by laminating the plastic materials with woven or non-woven fiberglass sheets. The increased mechanical strength imparted by the fiberglass laminates permits the levels of flammable binders and resin conventionally present in plastics to be reduced.

Preferred plastic materials having a reduced propensity to ignite, smoke, or deform when exposed to heat or flames comprise polyvinyl chloride, ammonium sulfate, and corn oil.

In yet another aspect of the invention, methods for manufacturing a plastic material having a reduced propensity to ignite, smoke, or deform when exposed to heat or flames are provided. The method generally comprises the steps of: (1) providing an extruder; (2) introducing a plastic polymer into the extruder; (3) introducing an intumescent composition into the extruder; and (4) obtaining an extrudate of the plastic polymer having the intumescent composition incorporated therein. The intumescent composition comprises: (a) an intumescent catalyst selected from the group consisting of salts of phosphoric acid and salts of sulfuric acid; and (b) a carbonific material selected from the group consisting of starches, sugars, sugar alcohols, oils, and plasticizers. If it is desired to manufacture a non-foamed plastic extrudate, the step of introducing the intumescent composition into the extruder is performed under conditions that substantially prevent the intumescent reaction from occurring in the extruder. The conditions that substantially prevent the intumescent reaction from occurring in the extruder may comprise a temperature below about 300° F. Alternatively, if a foamed plastic extrudate is desired, the step of introducing the intumescent composition into the extruder is performed under conditions that permit the intumescent reaction to substantially occur in the extruder. The conditions that permit the intumescent reaction to substantially occur may comprise a temperature above about 300° F.

In a related aspect of the invention, a method for manufacturing a plastic material having a reduced propensity to ignite, smoke, or deform when exposed to heat or flames is provided, comprising the steps of: (1) providing an extruder comprising: (a) a barrel having an upstream end and a downstream end, (b) a first feeder for introducing materials into said barrel, the first feeder being located at the upstream end of the barrel, (c) a second feeder for introducing materials into the barrel, the second feeder being located downstream from the first feeder; (2) introducing a plastic polymer into the barrel through the first feeder; (3) introducing an intumescent composition into the barrel through the second feeder; and (4) obtaining an extrudate of the plastic polymer having the intumescent composition incorporated therein. The intumescent composition comprises: (a) an intumescent catalyst selected from the group consisting of salts of phosphoric acid and salts of sulfuric acid; and (b) a carbonific material selected from the group consisting of starches, sugars, sugar alcohols, oils, and plasticizers. If it is desired to manufacture a foamed plastic, the conditions in the barrel at and downstream of the second feeder are selected to substantially prevent the intumescent reaction from occurring in the extruder. The conditions may comprise a temperature below about 300° F. Foamed plastics are obtained by selecting conditions in the barrel at and downstream of the second feeder which permit the intumescent reaction to substantially occur in the extruder. Such conditions may comprise a temperature above about 300° F.

An interesting variation of the method for manufacturing a foamed plastic material having a reduced propensity to ignite, smoke, or deform when exposed to heat or flames is also provided. The method comprises the steps of: (1) providing an extruder; (2) introducing a plastic polymer into the extruder; (3) introducing an intumescent composition into the extruder; (4) obtaining an extrudate of the plastic polymer having the intumescent composition incorporated therein which is not in the form of a foamed plastic; and (5) heating the extrudate under conditions that permit the intumescent reaction to substantially occur, thereby producing a foamed plastic. The intumescent composition according to this aspect of the invention comprises: (a) an intumescent catalyst selected from the group consisting of salts of phosphoric acid and salts of sulfuric acid; and (b) a carbonific material selected from the group consisting of starches, sugars, sugar alcohols, oils, and plasticizers.

The plastic extrudate formed by any of the methods of the invention may be shaped by passing the extrudate through a die, rolling the extrudate, or injecting the extrudate into injection molding equipment.

Plastic material made according to any of the foregoing methods are also provided.

These and other aspects of the invention will be better understood by reference to the following detailed description of the invention.

### DETAILED DESCRIPTION OF THE INVENTION

The intumescent compositions of the present invention comprise as essential components an intumescent catalysts and a carbonific material.

The intumescent catalyst is a dehydrating agent such as, for example, an acid or the salt of an acid. Suitable acids include both Brønsted-Lowry acids and Lewis acids. The acid catalyst may be introduced in a form, such as an ester or salt, which decomposes upon heating to yield acidic residues. Suitable intumescent catalysts include, but are not limited to, phosphoric acid, metaphosphoric acid, orthophosphoric acid, pyrophosphoric acid, polyphosphoric acid, sulfuric acid, and salts thereof. The intumescent catalysts may be present, for example, as the ammonium, amine, and amide salts of these acids. Particular mention may be made of ammonium phosphates, including (NH₄)H₂PO₄ (mono-ammonium phosphate or ammonium phosphate) and (NH₄)₂HPO₄ (di-ammonium phosphate), and ammonium sulfates, including (NH₄)₂SO₄ (ammonium sulfate or di-ammonium sulfate) and (NH₄)HSO₄ (ammonium hydrogen sulfate or ammonium bisulfate). Currently preferred intumescent catalysts are ammonium sulfates, especially (NH₄)₂SO₄.

The carbonific material is preferably a polyhydridic substance such as a polyalcohol (polyol) capable of producing carbon char. Suitable carbonifics include, but are not limited to sugars, such as, for example, glucose, fructose, maltose, and arabinose; sugar alcohols, such as, for example, erythritol, pentaerythritol including dimers and trimers thereof, arabitol, sorbitol, inositol, xylitol, and mannitol; polyhydridic phenols such as, for example, resorcinol; and starches such as, for example, corn starch, wheat starch, potato starch, and rice starch; and polyol containing adhesives. Starches, in particular corn starch, have been found useful in the practice of the invention. Currently preferred carbonifics are oils, including corn oil, vegetable oil, and soybean oil. Plasticizers which are capable of forming char, including without limitation, the dialkyl phthalates such as di-isononyl phthalate (DINP-S), di-isoundecyl phthalate (DIUP), dihexyl plithalate (DHP), and disotridecyl phthalate (DTDP) are also currently preferred carbonifics. Suitable dialkyl phthalate plasticizers that function as carbonifics or otherwise improve the flame retardancy, heat resistance, and smoke-suppressing properties of plastics when used in conjunction with the intumescent catalysts of the invention are obtainable from Exxon Mobil under the name Jayflex. In all embodiments, dialkyl phthalates are currently preferred when the carbonific is a plasticizer.

Accordingly, in one preferred embodiment of the invention, the intumescent composition comprises an intumescent catalyst comprising ammonium sulfates, including (NH₄)₂SO₄, and a carbonific selected from the group consisting of starches, oils, and plasticizers. The most preferred carbonifics are selected from the group consisting of corn starch, vegetable oil, corn oil, soil oil and dialkyl phthalates. Special mention may be made of corn oil. There is no particular limitation on the relative amounts of ammonium sulfates and cabonific in the intumescent compositions. However, it may be advantageous to employ a stoichiometric equivalent or excess of ammonium sulfates based on the number of reactive sites in the starch or oil (or other carbonific) to ensure rapid intumescence. The ratio of intumescent catalyst to carbonific is not limited and may be varied depending on the application. In one embodiment, the weight ratio of ammonium sulfates to starch is typically between about 1:10 and about 10:1, preferably between about 1:1 and about 6:1, and more preferably about 2:1.

In one embodiment, the intumescent compositions further comprise a blowing agent. However, it will be understood that blowing agents are not necessary to practice the invention. One skilled in the art will recognize that blowing agents are materials that decompose to volatile products and can be selected based on the desired temperature at which they decompose. The non-flammable gases released upon decomposition of the blowing agent causes the char to expand to the insulating cellular foam. Exemplary blowing agents include, but are not limited to, those substances that decompose to produce gaseous ammonia, carbon dioxide, and water vapor, such as, for example, dicyandiamide, melamine, guanidine, glycine, urea, and combinations thereof. Melamine, which has a decomposition temperature of approximately 480° F., is a currently preferred blowing agent. When the intumescent composition comprises ammonium phosphates or ammonium sulfates it is not necessary, and therefore optional, to include a blowing agent. Without wishing to be bound by any theory, it is believed that ammonia gas (NIH3), liberated by decomposition of ammonium phosphates or ammonium sulfates to the corresponding acid, is alone sufficient to provide a foamed char.

The intumescent compositions of the invention are useful for reducing the propensity of a substrate to ignite, smoke, or warp when exposed to heat or flames. The intumescent compositions may be applied to a surface, for example, as a protective coating using any method known in the art for formulating and applying such coatings. It is preferred, however, to incorporate the intumescent compositions into the substrate as an additive.

The substrate preferably comprises a polymeric material such as polypropylene, polyester, polyurethane, polyethylene, and vinyl. Preferred substrates comprise vinyl, and more preferably polyvinyl chloride (“PVC”). As used herein, the term “PVC” is meant to include homopolymers of vinyl chloride as well as copolymers of vinyl chloride containing other monovinylidene compounds copolymerizable therewith, including but not limited to vinyl esters, such as vinyl acetate, vinylidene chloride, and alkyl esters of unsaturated mono- or dicarboxylic acids such as acrylic acid, methacrylic acid, maleic acid and fumaric acid, including vinyl acetate, acrylate esters, and methacrylate esters, and olefins such as ethylene and propylene, and the like.

In one embodiment, the invention provides polymeric materials, including but not limited to polyester, polyurethane, polyethylene, polypropylene, and vinyl, having physically incorporated therein an intumescent composition of the invention. The polymeric materials may comprise the intumescent compositions in any amount. Typically, commercial polymers, such as those employed as building materials comprise, in addition to the plastic resin, various plasticizers, stabilizers, fillers, blending resins, pigments, and additives, as well known to one skilled in the art.

Any plasticizer, stabilizer, filler, or other additive known in the art may be used in the present invention. Suitable plasticizer, stabilizer, fillers, and other additives, include but are not limited to, those disclosed in U.S. Pat. No. 6,706,820 to Kumaki, et al., U.S. Pat. No. 5,552,484 to Enomoto, and U.S. Pat. No. 4,042,556 to Yoshinaga, the contents of which are hereby incorporated by reference herein. The plastics may further comprise U.V. stabilizers, colorants, and impact modifiers. Preferred additives include low flammability oils such as soybean and corn oils, calcium carbonate, calcium stearate, titanium dioxide, paraffin wax, oxidized PE lubricant, phthalate plasticizers, heat stabilizers and impact modifiers.

To enhance the flame retarding, smoke-suppressing and heat resisting properties of plastic materials, it is preferred to replace a portion of the additives and fillers, preferably flammable additives and fillers, with the intumescent compositions of the invention. Non-flammable components may also be replaced in whole or in part. For example, it has been found that common additives, including but not limited to calcium carbonate can be replaced in whole or in part with the intumescent additives. A typical plastic or vinyl material according to the invention will comprise about 60 wt. % and above plastic resin, up to about 25 wt. % intumescent catalyst, for example, ammonium sulfates, up to about 15 wt. % carbonific, including without limitation, starches and oils, and optionally a plasticizer as needed.

In a particularly preferred embodiment, the invention provides heat-resistant, flame retardant, and smoke-suppressing PVC vinyl siding. As is well known to the skilled artisan, PVC siding is typically manufactured by a coextrusion process wherein two layers of PVC are fused in a continuous extrusion process. The top layer is referred to as “capstock” and typically comprises 10% titanium dioxide and 3% calcium carbonate filler by weight of resin. The titanium dioxide provides resistance to breakdown from UV light and functions as a pigment. The lower layer, referred to as the “substrate,” typically comprises 10% calcium carbonate filler and 2% titanium dioxide by weight of resin. A typical 0.042 inch thick vinyl siding panel comprises 80% substrate (0.034 inch) and 20% capstock (0.008 inch). Because the capstock provides the attractive appearance and TV resistance of the vinyl siding, it is preferable to incorporate the intumescent compositions of the invention into the substrate. The composition of a typical vinyl siding substrate is provided in Table 1.

TABLE 1
VINYL SIDING FORMULATION

| | Substrate | Capstock |
|---|---|---|
| | Weight Percent | Weight Percent |
| Material | (based on PVC resin) | (based on PVC resin) |
| PVC Resin | 100 | 100 |
| Impact Modifier | 5.0 | 5.0 |
| Heat Stabilizer | 0.8 | 0.9 |
| Filler (CaCO₃) | 10.0 | 3.0 |
| Calcium Stearate | 1.4 | 1.4 |
| Processing Aid | 0.8 | 0.8 |
| Oxidized PE Lubricant | 0.15 | 0.15 |
| Paraffin Wax | 1.2 | 1.15 |
| TiO₂ | 2.0 | 10.0 |

The amounts of titanium dioxide and calcium carbonate in the substrate and capstock are conventionally selected to keep both extrusion stream equally fluid during the co-extrusion process. Replacing portions of titanium dioxide and/or calcium carbonate in the substrate layer with the intumescent compositions of the invention will not, however, preclude coextrusion, and it is within the skill in the art to formulate the substrate with appropriate additives to optimize the coextrustion with the capstock.

Therefore, in one embodiment of the invention, the substrate formulation in Table 1 has been modified by replacing all or part of the calcium carbonate and/or titanium dioxide with an intumescent composition comprising ammonium sulfates and corn starch. Similarly, the same material was modified by replacing all or part of the calcium carbonate and/or titanium dioxide with an intumescent composition comprising ammonium sulfates and corn oil. The resulting vinyl substrates had higher heat resistance, were less susceptible to ignition and produced less smoke when contacted with the flame of a propane torch as compared to a substrate having the formulation of Table 1.

The siding substrate according to one embodiment therefore comprises: (1) PVC resin; (2) optionally a plasticizer; (3) one or more optional additives; and (4) an intumescent additive comprising ammonium sulfates as an intumescent catalyst and oil or starch as a carbonific. In one embodiment the intumescent additive is present in about 25% by total weight of the vinyl material. Methods of making vinyl siding from PVC resins are well known in the art and disclosed in, for example, U.S. Pat. No. 4,110,062 to Summers, the contents of which are hereby incorporated by reference herein.

Further improvement to vinyl siding substrates are achieved by incorporating inert additives such as chopped fiberglass fibers or carbon fibers into the substrate. Various flammable and non-flammable components of the substrate may be replaced in any portion with the chopped fiberglass fibers. The addition of glass fibers to provide reinforcement for intumescent halogenated polymers is disclosed in U.S. Pat. No. 6,706,793 to Abu-Isa, et al. Suitable fibrous additives for use in the present invention are disclosed in U.S. Pat. No. 6,706,793, the contents of which are hereby incorporated by reference herein. When present, the inert fibers may be added to the plastic substrate in an amount to achieve a desired rigidity and strength of the resultant plastic, as is well within the ordinary skill in the art.

The addition of the intumescent materials of the invention with or without addition of inert fibers is believed to provide vinyl siding that meets or surpasses American Society of Testing and Materials (ASTM) Standard D3679 requirements of camber, heat shrinkage, linear expansion, surface distortion, impact resistance, windload resistance, and weathering performance. Remarkable improvement has been observed in surface distortion when vinyl substrate according to the present invention is subjected to heat and flame.

In another embodiment of the invention, the fire resistant vinyl substrates of the invention are laminated with fiberglass mats, non-woven fiber glass, or fiberglass scrim. Woven and non-woven fiberglass mats and fiberglass scrim are well known in the art and are disclosed in, for example, U.S. Pat. No. 6,548,155 to Jaffee, U.S. Pat. No. 6,743,742 to LaRocco, et al., U.S. Pat. No. 6,564,437 to Meng, et al.; U.S. Pat. No. 6,503,425 to Thorbjornsson, et al., U.S. Pat. No. 6,093,485 to Jaffee, U.S. Pat. No. 5,865,003 to Klett, et al., and U.S. Pat. No. 5,935,879, the disclosures of which are hereby incorporated by reference herein.

The woven fiberglass mats, non-woven fiber glass, or fiberglass scrim may be incorporated between the substrate and capstock using high temperature controlled rolling equipment operating at approximately 400° F. and between 1,000 and 5,000 PSI, or any like method known in the art. Under such conditions, it is not necessary to use adhesives to apply the fiberglass mat. A vinyl siding according to this aspect of the invention will typically comprise from about 20% to about 60% fiberglass. Thus, it is possible to reduce the amount of substrate used while maintaining the mechanical integrity of the siding. This has the benefit of reducing the overall flammable and smoke-producing content of the siding. In one embodiment, a vinyl siding comprises about 20% capstock, about 20% substrate, and about 60% fiberglass mats, non-woven fiber glass, or fiberglass scrim.

The present invention also provides methods of extruding flame retardant, heat-resistant, smoke-suppressing plastics, such as PVC. Conventional methods for extruding vinyl resins, such as PVC, are well known in the art, as disclosed in, for example, U.S. Pat. Nos. 6,350,400 to Piotrowski, U.S. Pat. Nos. 4,322,170 to Papenmeier; U.S. Pat. Nos. 3,983,186 to Eilers, et al., M. J. Stevens, “Extruder Principals and Operation”, Elsevier Applied Science Publishers, New York, N.Y. (1985), and C. Rauwendaal, “Polymer Extrusion”, Hanser Publishers, New York, N.Y. (1986), the content of which are hereby incorporated by reference herein.

Generally, a polymer extruder comprises a uniform bore barrel ranging from ¾″ to 24″ inner diameter and a screw disposed in the lumen of the barrel which extends the length of the barrel. The screw is rotated by a gear box connected to a motor. Rotation of the screw flights drives the melted thermoplastic resin through the barrel. A hopper containing the polymer resin material in the form of powder or pellets is located at the upstream end of the barrel. The resin is continuously pulled into the barrel between the flights by the action of gravity or pressure. The ratio of the length of the screw to the inside diameter of the barrel (“L/D ration”) may vary, and is typically, but not necessarily, approximately 30:1

Common screws are divided into one or more sections. A typical single stage screw has three sections of varying root diameter of the screw. The first section, the feeder zone, located near the hopper, may have a constant root diameter and large flight depths for mixing the material. In the second section, the compression or transition zone, the root diameter may expand, reducing the volume between flights, in order to compress the material. In this manner, the material is melted through, in part, frictional heating from rotary shear. The transition zone varies from a single flight to as many as eight flights in common screw designs and often spans from one-fourth to one-third the entire screw length. Since substantial frictional heating occurs in this section, careful control over the temperature and pressure is observed to prevent overheating of the material. The third section, the metering zone, typically has a minimal flight depth and an expanded root diameter. The metering section provides melt stability and uniform delivery rates of extrudate. The length of the metering section may be varied to control temperature and polymer stability.

Two-stage screws are also well known and commonly used in vented extruders. Two-stage screws comprise two sections, each having the characteristic of single stage screws described above. The first stage commonly comprises about 60% of the overall length of the screw (approximately 17 flights) and the second stage commonly comprises, about 40% (approximately 15 flights) of the overall length of the screw in a typical 32:1 L/D ratio extruder.

Common screw designs including standard, metering, Maddock, or barrier/mixing screws, are well known in the art. Some screws have cored sections for circulating a coolant such as water to provide further control over temperature.

One or more heater bands which may be independently controlled are positioned along the length of the barrel to melt the resin. Common temperature profiles known in the art can be used to achieve optimal dwell times and melts. These include graduated, humpback, or reverse temperature profiles. The barrel may optionally be vented to prevent the build up of pressure from volatile components. Side feeders may also be present which allow the introduction of components downstream from the hopper. The melted polymer may be forced through a dye at the terminal end of the barrel to shape the resulting extrudate or the extrudate may be forced into a mold at the terminal end of the barrel in the injection molding process. The skilled artisan will recognize the numerous variations of the extrusion process, such as for example, twin screw extrusion, which also may be employed.

Twin screw extrusion may provide greater flexibility over the operating conditions to suit the demands of a particular formulation. Typically, a twin-screw extruder comprises two conical or parallel screws, each traversing the length of the barrel. The two screws may be co-rotating or counterrotating, intermeshing or nonintermeshing. The design of the screws may also be varied by including, for example forward conveying elements, reverse conveying elements, and leading blocks. Twin screw extrusion is discussed generally in J. L. White, Twin Screw Extrusion: Technology and Principles, Hanser Publishers, New York (1991), the contents of which are hereby incorporated by reference. Suitable twin screw extruders include, but are not limited to, those described in U.S. Pat. Nos. 6,688,217 and 6,609,819 to Hauck, et al.; U.S. Pat. No. 6,179,460 to Burdhardt, et al.; U.S. Pat. No. 6,059,440 to Fuchs; U.S. Pat. No. 5,728,337 to Yoshikawa, et al.; and U.S. Pat. No. 5,000,900 to Baumgartner, the contents of which are hereby incorporated by reference herein.

In light of the wide variation of extruder designs known in the art, it is not generally possible to establish a universal set of operating parameters to be used in the manufacturing methods of the invention. However, this variability does not preclude the skilled artisan from practicing the invention using any extruding equipment known in the art because only routine optimization is required to adapt the methods disclosed herein to any extruding equipment. The skilled artisan will be guided by the inventive principles herein set forth.

For example, different screw and extruder designs provide for varying barrel lengths, compression ratios, shear, etc., and consequently the pressure and frictional heating of the materials will depend on the selection of extruder equipment. In some embodiments of the invention, it is desirable to achieve control over the intumescent reaction within the extruder, either by permitting or discouraging the reaction. The development of the intumescent reaction will depend on factors such as pressure and temperature. It has generally been found that the intumescent reaction is accelerated at temperatures above about 300° F. over a wide range of common operating pressures. Alternatively, lower temperatures, for example 200° F. to about 300° F., discourage the intumescent reaction over a wide range of common operating pressures. The art of extrusion is, however, flexible and it is recognized that the skilled artisan may deviate from these temperature ranges by, for example, adjusting the compression, temperature, or use of various additives known in the art. Further, one may control the development of the intumescent reaction by introducing the intumescent material at downstream locations in the extruder barrel using, for example, one or more side feeders, located in the feed, compression, or metering zones. All such variations do not depart from the spirit of the invention.

Therefore, in the broadest sense, the manufacturing method of the invention comprises the steps of: (a) introducing a plastic material into an extruder; (b) introducing the intumescent composition of the invention into the extruder; and (c) forming an extrudate of the resulting mixture. These steps may be performed by adding both the plastic and the intumescent composition through the main hopper or the intumescent composition may be added at a location downstream from the main hopper.

The conditions may be adjusted to either encourage or discourage the occurrence of the intumescent reaction during the extrusion. As discussed above, the skilled artisan will be guided by the observation that the intumescent reaction is encouraged at temperatures above about 300° F. at the operating compressions and temperatures attained in standard single screw extruders having a compression ratio of about 2.5:1 to about 5:1 (calculated as the relative flight depth in the feed and metering zones) without external heating. The development of the intumescent reaction effects the characteristics of the resulting plastic. However, it will be recognized that all plastics so made, whether or not the intumescent reaction develops in the extruder, are within the scope of the invention. The development of the intumescent reaction in the extrusion barrel has surprisingly been found to provide plastics having the properties of a foam. In contrast, by discouraging the reaction, solid non-foamed plastics (e.g. vinyl siding) are obtained. Further, plastics having interesting physical properties in between those of foams and non-foams (i.e., partially foamed plastics) may also be produced. All plastics made according to the manufacturing methods of the invention have flame retarding, smoke-suppressing, and heat resisting properties superior to conventional plastics made without the intumescent additives of the invention.

One embodiment of the manufacturing method of the invention comprises the steps of (a) introducing a plastic resin, such as PVC, in the form of pellets or powder into an extruder; (b) optionally introducing a plasticizer and one or more optional fillers or additives into the extruder; and (c) introducing an intumescent composition of the invention into the extruder; and (d) forming an extrudate of the resultant flame retarding, smoke-suppressing, and heat resisting plastic.

Semi-rigid or rigid vinyl siding may be prepared by introducing the plastic and intumescent composition of the invention into an extruder through the main hopper and extruding the mixture at conditions of sufficiently low temperature such that the intumescent reaction does not substantially occur. As used herein, the intumescent reaction does not “substantially” occur if the resulting extruded plastic does not have the well known characteristics of a foam (e.g. voids caused by encapsulation of air pockets). Alternatively, semi-rigid or rigid vinyl siding may be prepared by introducing the intumescent composition of the invention into an extruder at a location sufficiently downstream from the location at which the polymeric resin is introduced and at a sufficiently low temperature such that the intumescent reaction does not substantially occur.

In one embodiment contemplated to be particularly useful for extruding PVC plastics, the extruder is a single or twin screw extruder having one or more side feeders and multiple heat zones. For example, an Egans, 250 hp 4½″ single screw extruder having four to ten heat zones is contemplated to be useful in the practice of the invention. Optionally, cored screws may be used to provide pressure control. Maddock mixing screws may also be used to optimize the melt and flow characteristics of the extrudate. Reducer gears ranging from 11:1 to 25:1 have been found to provide the necessary torque to achieve sufficient throughput. The heat zones may comprise heating elements or cooling elements to control the temperature within a segment of the barrel. The temperature in the barrel, which derives in part from friction, is optimally controlled to provide the correct melt but will vary depending on the desired characteristics of the product.

For PVC vinyl siding applications, twin screw extruders using a 130 mm primary extruder mated with a 60 mm satellite extruder with five heat zones is contemplated to be useful. Any similar extruder is contemplated to be useful.

Preferably, the extruder comprises one or more side feeders to provide the ability to introduce materials downstream of the main hopper. In one embodiment of the invention, the powdered or pelletized PVC resin, optional plasticizer, and other additives are introduced into the extruder through the main hopper in a conventional manner. The intumescent composition may be added to the extruder through a side feeder located downstream from the hopper from which the PVC resin was introduced. The temperature within the barrel upstream from the side feeder in which the intumescent composition is introduced is preferably maintained at or above about 300° F. It is within the skill in the art to determine the optimal temperature in these zone to provide sufficient melt and flow. The intumescent compositions should optimally be introduced through a side feeder sufficiently close to the terminal end of the extruder so that mixing is achieved but the intumescent reaction between the ammonium sulfates and the starch or oil does not substantially occur, owing in part to the short path of the barrel which the intumescent compound traverses. In the case of the Egans extruder described above, the intumescent composition is added through a side feeder located at heat zone 3 of 5 from the hopper. The temperature in the barrel in the zone in which the intumescent composition is added is preferably kept below about 300° F. to discourage the intumescent reaction. It is within the skill in the art to optimize the temperature at this point to provide sufficient flow and to discourage the intumescent reaction from substantially occurring. The extrudate may be shaped using rollers, dyes, and the like to provide molded heat-resistant, fire-retardant, smoke-suppressing semi rigid vinyl material such as vinyl siding. It will be recognized that rigid vinyl materials can similarly be prepared by reducing the amount of plasticizer in the formulation. Alternatively, flexible vinyl extrudate may be obtained in a similar manner by selecting, for example, appropriate additives, as well known to the skilled artisan. In an interesting variation of this process, the intumescent composition is added through the side feeder located at heat zone 3 of 5 from the hopper, however, the temperature is adjusted in this zone to encourage the intumescent reaction. The resulting plastic takes the form of a heat-resistant, flame retarding, smoke-suppressing foam.

In another variation of this process, the intumescent composition is introduced through a side feeder at an intermediate location downstream of the main hopper, but farther upstream than in the embodiment described above, such as heat zone 2 of 5 of the Egans extruder. In this variation, the intumescent composition is added to the extrusion sufficiently upstream of the terminal end of the extruder such that the intumescent reaction develops as the extrudate traverses the remaining sections of the extrusion barrel. In this variation, the temperature downstream of the side feeder is preferably maintained at 300° F. or above in order to encourage the intumescent reaction. The resultant extrudate is in the form of a heat-resistant, fire-retardant, smoke-suppressing vinyl foam.

It will be noted that satisfactory plastic foams may also be obtained by adding the intumescent material in the extrusion process together with the plastic resin through the main hopper and allowing the mixture to traverse the entire extrusion barrel. It will be observed that the temperature should not be so high that the intumescent composition is depleted through reaction as the resultant plastic foams may lack the desired heat-resistant, fire-retardant, and smoke-suppressing properties.

Conventional vinyl foams, such as those disclosed in U.S. Pat. Nos. 3,983,296 and 4,120,833 to Purvis, et al., U.S. Pat. No. 4,017,657 to Foley, et al., U.S. Pat. No. 4,042,556 to Yoshinaga, U.S. Pat. Nos. 5,391,585 and 5,324,461 to Grohman, U.S. Pat. No. 5,686,025 to Martin, U.S. Pat. Nos. 5,783,613 and 5,786,399 to Beekiman et al., U.S. Pat. Nos. 6,225,365 and 6,225,365 to Zerafati, et al., and S. K. Dey et al. “Inert-Gas Extrusion of Rigid PVC Foam” Journal of Vinyl & Additive Technology, March 1996, Vol. 2, No. 1., the contents of which are hereby incorporated by reference herein, have required the addition of chemical or physical blowing agents to create the cellular structure of the foam. The vinyl foams of the present invention do not require the addition of blowing agents, rather the evolution of gas is believed to derive from at least partial development of the intumescent reaction in the extruder. However, the use of blowing agents is not precluded in the practice of the invention.

In another variation of the process for manufacturing vinyl foams, a similar extrusion process used to prepare semi-rigid vinyl products may be used first to produce a non-foamed pelletized vinyl comprising the intumescent compositions. That is, the intumescent material is introduced through a side feeder at or toward the terminal end of the extrusion barrel such that the intumescent reaction does not appreciably occur. The vinyl pellets comprising the intumescent materials may then be re-introduced into the an extruder to produce foamed or non-foamed profile or molded plastic.

Surprisingly, the plastic products of the invention have physical and mechanical properties comparable or equal to those of plastic materials that do not have the intumescent additives incorporated therein. It is well known in the art the addition of additives, such as fire-retardants, to plastics generally weakens the plastic materials, a phenomenon that has heretofore been a disadvantage associated with the use of fire-retardants in products such as vinyl siding. The present invention overcomes this disadvantage of the prior art by providing heat-resistant, fire-retardant, smoke-suppressant plastics having superior physical properties and mechanical properties (i.e., structural integrity) comparable or superior to conventional plastics.

The heat-resistant, fire-retardant, smoke-suppressing plastic foams of the invention are contemplated to be an effective replacement for components of vinyl siding, vinyl panels, and composite barrier panels and the like. Specific applications include, but are not limited to fire door core materials, architectural door core materials, composite fire proof panels for ships, trains, aircraft, automotives, etc.

### EXAMPLE 1

A heat-resistant, flame retardant, smoke-suppressing semi-rigid PVC material was prepared according to the methods of the invention. A Werner & Pfleiderer twin screw extruder having co-rotating, general purpose mixing and metering screws was use to extrude the PVC material. The extruder had a 30 inch barrel length and a 30:1 L/D ratio. Six uniformly spaced heat zones are disposed about the length of the barrel. The heat bands were set to maintain the temperature in the zone between about 338° F. and 374° F. A compounded PVC resin and an intumescent composition were introduced into the main hopper of the extruder. The intumescent composition consisted of ammonium sulfate and corn oil in a weight ratio of 2:1. The compounded vinyl formulation is provided in Table 2. The ratio of compounded resin to intumescent composition was approximately 3:1.

TABLE 2

| | Weight Percent |
|---|---|
| Material | (based on PVC resin) |
| PVC Resin | 100 |
| Impact Modifier | 5.0 |
| Heat Stabilizer | 0.8 |
| Filler (CaCO₃) | 0 |
| Calcium Stearate | 1.4 |
| Processing Aid | 0.8 |
| Oxidized PE Lubricant | 0.15 |
| Paraffin Wax | 1.2 |
| TiO₂ | 2.0 |

The extrudate was a foamed plastic having a skin with the surface characteristics of semi-rigid PVC. The extrudate was shaped into a continuous strip to produce heat-resistant, fire-retardant, smoke-suppressing foamed vinyl bars having a cross-sectional dimension of 0.75″ by 0.25″.

A second sample of compounded PVC having the formulation provide in Table 3 was extruded under identical conditions, however, without the addition of an intumescent additive. This material was also shaped into bars having a cross-sectional dimension of 0.75″ by 0.25″. This sample was prepared to serve as a control in the tests described below

TABLE 3

| | Weight Percent |
|---|---|
| Material | (based on PVC resin) |
| PVC Resin | 100 |
| Impact Modifier | 5.0 |
| Heat Stabilizer | 0.8 |
| Filler (CaCO₃) | 10 |
| Calcium Stearate | 1.4 |
| Processing Aid | 0.8 |
| Oxidized PE Lubricant | 0.15 |
| Paraffin Wax | 1.2 |
| TiO₂ | 2.0 |

The plastic bars of the invention and the control bars of conventional plastic were exposed to the flame of a propane torch having a flame temperature of about 1,850° F. which was held approximately three inches from each bar.

Within three seconds, the control bar began to smoke effusively and showed signs of flare up and deformation. At 5 seconds, substantial quantities of black smoke was emanating from the sample. In contrast, the plastic bars of the invention having the intumescent additives did not produce smoke and did not deform after five second. At eight seconds, light white smoke was noted in the inventive sample and an intumescent char was created. During the duration of the exposure to flame, no appreciable melting had occurred and no flare-up was noted in the inventive sample.

### EXAMPLE 2

This example provides heat-resistant, flame retardant, smoke-suppressing PVC siding. The Capstock is a conventionally capstock. The substrate contains an intumescent composition comprising ammonium sulfate and corn oil in weight ratio of 2:1. The substrate is prepared according to the formulation shown in Table 4.

TABLE 4
VINYL SIDING FORMULATION

| | Substrate | Capstock |
|---|---|---|
| | Weight Percent | Weight Percent |
| Material | (based on PVC resin) | (based on PVC resin) |
| PVC Resin | 100 | 100 |
| Impact Modifier | 5.0 | 5.0 |
| Heat Stabilizer | 0.8 | 0.9 |
| Filler (CaCO₃) | 0 | 3.0 |
| Calcium Stearate | 1.4 | 1.4 |
| Processing Aid | 0.8 | 0.8 |
| Oxidized PE Lubricant | 0.15 | 0.15 |
| Paraffin Wax | 1.2 | 1.15 |
| TiO₂ | 2 | 10.0 |
| Intumescent | 27.75 | 0 |

### EXAMPLE 3

A heat-resistant, flame retardant, smoke-suppressing semi-rigid PVC material is prepared according to the methods of the invention.

An Egans, 250 lip, 4½″ single screw extruder with a side feeder positioned downstream from the main hopper at heat zone 3 of 5 is used to extrude the PVC material. Five heating bands are uniformly disposed along the length of the extrusion barrel.

The materials in Table 2 are introduced into the main hopper. An intumescent composition comprising ammonium sulfate and corn oil in a weight ratio of 2 to 1 is added to the extruder through the side feeder. The ratio of compounded PVC to intumescent material is approximately 3:1. The heating bands upstream from the side feeder in which the intumescent composition is introduced are maintained at about 300-400° F. and the downstream heating bands are set at about 200-300° F. The extrudate is forced through a dye to produce a heat-resistant, fire-retardant, smoke-suppressing semi-rigid vinyl which is then rolled into continuous sheets.

### EXAMPLE 4

A heat-resistant, flame retardant, smoke-suppressing semi-rigid PVC material was prepared by milling the compounded PVC resin of Table 2 and an intumescent material comprising two parts ammonium sulfate and one part corn starch. The compounded PVC and was mixed with the intumescent material in a 3:1 ratio by weight. The mixture was poured onto the rollers of an Albert, two-roll mill having 6 inch diameter, 12 inch long rollers. The rollers were heated to about 385° F. using an oil fired heater. The rolled material was subjected to multiple passes through the rollers to produce flat panels of PVC containing the intumescent material.

The resultant PVC panels were cut into 3 inch by 11 inch panels having a thickness of 0.042 inches. Conventional ribbed vinyl siding according to Table 1, including substrate and capstock, having a thickness of 0.042 inches was used as a control.

Samples of the PVC panels of the invention were loosely hung side by side with the conventional PVC siding panels against a wall using one screw atop each panel. The panels were hung such that the 11 inch dimension was vertical. A commercial outdoor grill (Jennair) was placed 15 inches from the panels and heated to 600° F.

After two minutes of heating, the conventional vinyl siding began to deform (i.e. warp). Between two and five minutes, the conventional siding warpage in the convention siding had become so severe that it was no longer suitable for use as siding (that is, it became highly curled at the ends and warped to such a degree across the entire panel that it could not lay flat against the wall). After five minutes of heating, the PVC material of the invention was not noticeably effected and maintained its linear flatness. After 10 minutes of heating, the PVC of the invention began to develop a slight crowning along the 3 inch length, but otherwise maintained its original dimensions. At the same time, the conventional PVC continued to deteriorate to the point where its original dimensions were no longer evident. After 30 minutes of heating, the PVC material of the invention had displayed only slight crowning about the 3 inch dimension but otherwise had not lost its original dimensions and maintained an attractive appearance. In contrast, the convention PVC had clearly reaches its softening point and displayed excessive warpage. This test demonstrates that the heat-resistant properties of the inventive plastic are far superior to conventional plastics. In this example, it is notable that the conventional PVC siding was ribbed was the PVC panel of the invention was not ribbed. These results are therefore all the more remarkable, as it is known that ribbing provides added protection against deformation. Further, it is believed that the slight crowning observed in the inventive PVC samples was due to relaxation of shaping stresses rather than softening of the plastic. This theory is reinforced by the fact that the observed crowning, once it appeared, did not progress over time.

### EXAMPLE 5

A heat-resistant, flame retardant, smoke-suppressing semi-rigid PVC material was prepared by milling the compounded PVC resin of Table 2 and an intumescent material comprising two parts ammonium sulfate and one part corn starch. The compounded PVC and was mixed with the intumescent material in a 3:1 ratio by weight. The mixture was poured onto the rollers of an Albert, two-roll mill having 6 inch diameter, 12 inch long rollers. The rollers were heated to about 385° F. using an oil filled heater. The rolled material was subjected to multiple passes through the rollers to produce flat panels of PVC containing the intumescent material.

The resultant PVC panels were cut into 3 inch by 11 inch panels having a thickness of 0.042 inches. Conventional vinyl siding substrate according to Table 1 was milled by the same method and rolled into panels having a thickness of 0.042 inches and cut into 3 inch by 11 inch panels for use as a control.

The panels were exposed to the flame of a propane torch having a flame temperature of about 1,850° F. which was held approximately three inches from the face of each panel. Within five seconds, the conventional PVC panel began to ignite and melt, producing a large volume of smoke. Within five seconds, the deformation of the panel was so extreme that it had substantially lost its liner flatness and original dimensions and had completely burned through. The panels made according to the invention produced substantially less smoke and deformation under the same conditions. No melting, flare-up, or burn-through was observed in the panels of the invention. Also, the burn area was substantially smaller that that of conventional PVC.

Interestingly, it was observed that the panels made of the inventive plastics had swollen in thickness to about ¾ inch due to the intumescent reaction and resulting insulating foam char.

It will be understood that the recitation of ranges contained herein are as a matter of convenience only and the inventors are in possession of every value intermediate within the ranges. That is, every intermediate value or sub-range within a disclosed range should be understood to be inherently disclosed. Further, every combination of the polymers, intumescent catalysts, and carbonifics disclosed herein are in the possession of the inventors and are not separately listed as a matter of convenience only.

The invention having been described by the foregoing description of the preferred embodiments, it will be understood that the skilled artisan may make modifications and variations of these embodiments without departing from the spirit or scope of the invention as set forth in the following claims.

1. A plastic material comprising:
(1) a plastic polymer; and
(2) an intumescent composition, said intumescent composition comprising:
(a) an intumescent catalyst selected from the group consisting of salts of phosphoric acid and salts of sulfuric acid; and
(b) a carbonific material selected from the group consisting of starches, sugars, sugar alcohols, oils, and plasticizers;
said plastic material having a reduced propensity to ignite, smoke or deform when exposed to heat or flames.

2. The plastic material of claim 1 wherein said plastic polymer comprises a polymer selected from the group consisting of polyvinyl chloride, polyester, polypropylene, polyethylene, and polyurethane.

3. The plastic material of claim 2 wherein said plastic polymer comprises polyvinyl chloride.

4. The plastic material of claim 1 wherein said intumescent catalyst comprises a salt selected from the group consisting of ammonium phosphates and ammonium sulfates.

5. The plastic material of claim 4 wherein said intumescent catalyst comprises (NH₄)₂SO₄.

6. The plastic material of claim 1 wherein said carbonific material comprises a material selected from the group consisting of erythritol, corn starch, corn oil, vegetable oil, and dialkyl phthalates.

7. The plastic material of claim 1 wherein said carbonific material comprises corn oil or vegetable oil.

8. The plastic material of claim 1, further comprising a plasticizer.

9. The plastic material of claim 1, further comprising one or more additives selected from the group consisting of stabilizers, fillers, blending resin, pigments, lubricants, and impact modifiers.

10. The plastic material of claim 1 further comprising glass or carbon fibers.

11. The plastic material of claim 1, having laminated thereto a fiberglass material selected from the group consisting of woven fiber glass, non-woven fiberglass, and fiberglass scrim.

12. A plastic material comprising:
(1) a plastic polymer selected from the group consisting of polyvinyl chloride, polyester, polypropylene, polyethylene, and polyurethane; and
(2) an intumescent composition, said intumescent composition comprising:
(a) an intumescent catalyst comprising (NH₄)₂SO₄; and
(b) a carbonific material selected from the group consisting of corn starch, corn oil, vegetable oil, and dialkyl phthalates.
said plastic material having a reduced propensity to ignite, smoke or deform when exposed to heat or flames.

13. The plastic material of claim 12 wherein said plastic polymer is polyvinyl chloride.

14. The plastic material of claims 12 or 13 wherein said carbonific material comprises corn oil.

15. The plastic material of claims 12 or 13 wherein said carbonific material comprises a dialkyl phthalate.

16. A plastic material comprising:
(1) polyvinyl chloride; and
(2) an intumescent composition, said intumescent composition comprising:
(a) an intumescent catalyst comprising (NH₄)₂SO₄; and
(b) a carbonific material comprising corn oil;
said plastic material having a reduced propensity to ignite, smoke or deform when exposed to heat or flames.

17. The plastic material of claims 12 or 16 further comprising glass or carbon fibers.

18. The plastic material of claims 12 or 16, having laminated thereto a fiberglass material selected from the group consisting of woven fiber glass, non-woven fiberglass, and fiberglass scrim.

19. A foamed plastic material comprising:
(1) a plastic polymer; and
(2) an intumescent composition, said intumescent composition comprising:
(a) an intumescent catalyst selected from the group consisting of salts of phosphoric acid and salts of sulfuric acid; and
(b) a carbonific material selected from the group consisting of starches, sugars, sugar alcohols, oils, and plasticizers;
said plastic material having a reduced propensity to ignite, smoke or deform when exposed to heat or flames, said plastic material having the form of a foam.

20. The foamed plastic material of claim 19 wherein said plastic polymer comprises a polymer selected from the group consisting of polyvinyl chloride, polyester, polypropylene, polyethylene, and polyurethane.

21. The foamed plastic material of claim 20 wherein said plastic polymer comprises polyvinyl chloride.

22. The foamed plastic material of claim 19 wherein said intumescent catalyst comprises a salt selected from the group consisting of ammonium phosphates and ammonium sulfates.

23. The foamed plastic material of claim 22 wherein said intumescent catalyst comprises (NH₄)₂SO₄.

24. The foamed plastic material of claim 19 wherein said carbonific material comprises a material selected from the group consisting of erythritol, corn starch, corn oil, vegetable oil, and dialkyl phthalates.

25. The foamed plastic material of claim 19 wherein said carbonific material comprises corn oil or vegetable oil.

26. The plastic material of claim 19, further comprising a plasticizer.

27. The foamed plastic material of claim 19, further comprising one or more additives selected from the group consisting of stabilizers, fillers, blending resin, pigments, lubricants, and impact modifiers.

28. The foamed plastic material of claim 19 further comprising glass or carbon fibers.

29. The foamed plastic material of claim 19, having laminated thereto a fiberglass material selected from the group consisting of woven fiber glass, non-woven fiberglass, and fiberglass scrim.

30. A foamed plastic material comprising:
(1) a plastic polymer selected from the group consisting of polyvinyl chloride, polyester, polypropylene, polyethylene, and polyurethane; and
(2) an intumescent composition, said intumescent composition comprising:
(a) an intumescent catalyst comprising (NH₄)₂SO₄; and
(b) a carbonific material selected from the group consisting of corn starch, corn oil, vegetable oil, and diallyl phthalates.
said plastic material having a reduced propensity to ignite, smoke or deform when exposed to heat or flames and having the form of a form.

31. The foamed plastic material of claim 30 wherein said plastic polymer is polyvinyl chloride.

32. The foamed plastic material of claims 30 or 31 wherein said carbonific material comprises corn oil.

33. The foamed plastic material of claims 30 or 31 wherein said carbonific material comprises a dialkyl phthalate.

34. A foamed plastic material comprising:
(1) polyvinyl chloride; and
(2) an intumescent composition, said intumescent composition comprising:
(a) an intumescent catalyst comprising (NH₄)₂SO₄; and
(b) a carbonific material comprising corn oil;
said plastic material having a reduced propensity to ignite, smoke or deform when exposed to heat or flames and having the form of a foam.

35. The foamed plastic material of claims 30 or 34 further comprising glass or carbon fibers.

36. The foamed plastic material of claims 30 or 34, having laminated thereto a fiberglass material selected from the group consisting of woven fiber glass, non-woven fiberglass, and fiberglass scrim.

37. A method for manufacturing a plastic material having a reduced propensity to ignite, smoke, or deform when exposed to heat or flames, comprising the steps of:
(1) providing an extruder;
(2) introducing a plastic polymer into said extruder;
(3) introducing an intumescent composition into said extruder, said intumescent composition comprising:
(a) an intumescent catalyst selected from the group consisting of salts of phosphoric acid and salts of sulfuric acid; and
(b) a carbonific material selected from the group consisting of starches, sugars, sugar alcohols, oils, and plasticizers; and
(4) obtaining an extrudate of said plastic polymer having said intumescent composition incorporated therein.

38. The method of claim 37, wherein said step of introducing said intumescent composition into said extruder is performed under conditions that substantially prevent the intumescent reaction from occurring in said extruder and wherein said extrudate is not in the form of a foamed plastic.

39. The method of claim 38, wherein said conditions that substantially prevent the intumescent reaction from occurring in said extruder comprise a temperature below about 300° F.

40. The method of claim 37, wherein said step of introducing said intumescent composition into said extruder is performed under conditions that permit the intumescent reaction to substantially occur in said extruder and wherein said extrudate is in the form of a foamed plastic.

41. The method of claim 40, wherein said conditions that permit the intumescent reaction to substantially occur comprise a temperature above about 300° F.

42. A method for manufacturing a plastic material having a reduced propensity to ignite, smoke, or deform when exposed to heat or flames, comprising the steps of:
(1) providing an extruder comprising:
(a) a barrel, said barrel having an upstream end and a downstream end,
(b) a first feeder for introducing materials into said barrel, said first feeder being located at the upstream end of said barrel,
(c) a second feeder for introducing materials into said barrel, said second feeder being located downstream from said first feeder;
(2) introducing a plastic polymer into said barrel through said first feeder;
(3) introducing an intumescent composition into said barrel through said second feeder, said intumescent composition comprising:
(a) an intumescent catalyst selected from the group consisting of salts of phosphoric acid and salts of sulfuric acid; and
(b) a carbonific material selected from the group consisting of starches, sugars, sugar alcohols, oils, and plasticizers; and
(4) obtaining an extrudate of said plastic polymer having said intumescent composition incorporated therein.

43. The method of claim 42, wherein conditions in the barrel at and downstream of said second feeder substantially prevent the intumescent reaction from occurring in said extruder and wherein said extrudate is not in the form of a foamed plastic.

44. The method of claim 43, wherein said conditions that substantially prevent the intumescent reaction from occurring in said extruder comprise a temperature below about 300° F.

45. The method of claim 42, wherein conditions in the barrel at and downstream of said second feeder permit the intumescent reaction to substantially occur in said extruder and wherein said extrudate is in the form of a foamed plastic.

46. The method of claim 45, wherein said conditions that permit the intumescent reaction to substantially occur comprise a temperature above about 300° F.

47. A method for manufacturing a foamed plastic material having a reduced propensity to ignite, smoke, or deform when exposed to heat or flames, comprising the steps of:
(1) providing an extruder;
(2) introducing a plastic polymer into said extruder;
(3) introducing an intumescent composition into said extruder, said intumescent composition comprising:
(a) an intumescent catalyst selected from the group consisting of salts of phosphoric acid and salts of sulfuric acid; and
(b) a carbonific material selected from the group consisting of starches, sugars, sugar alcohols, oils, and plasticizers; and
(4) obtaining an extrudate of said plastic polymer having said intumescent composition incorporated therein; wherein said extrudate is not in the form of a foamed plastic; and
(5) heating said extrudate under conditions that permit the intumescent reaction to substantially occur; thereby producing a foamed plastic.

48. The method of any of claims 37-47 further comprising the step of injection molding.

49. A plastic material comprising polyvinyl chloride, ammonium sulfate, and corn oil, said plastic material having a reduced propensity to ignite, smoke, or deform when exposed to heat or flames.

50. A plastic material made by the method of any of claims 37, 42, and 47.
